(19) United States
(12) Patent Application Publication
(10) Pub. No.: US 2024/0400769 A1
(43) Pub. Date: Dec. 5, 2024

(54) METHOD FOR IMPROVING THE REACTIVE EXTRUSION OF A POLYPROPYLENE PCR

(71) Applicant: Braskem S.A., Camaçari (BR)

(72) Inventors: Marcelo Farah, São Paulo City (BR); Alexandre Ozorio Soares, São Paulo City (BR); Nelson Beuter Junior, São Paulo City (BR); Tadeu Mezacasa Forest, São Paulo (BR)

(73) Assignee: Braskem S.A., Camaçari (BR)

(21) Appl. No.: 18/679,109

(22) Filed: May 30, 2024

Related U.S. Application Data
(60) Provisional application No. 63/469,994, filed on May 31, 2023.

(51) Int. Cl. C08J 3/22; B29C 48/00; B29C 48/395; B29C 48/40; B29K 23/00; C08J 11/06; C08K 5/14; C08L 23/12; C08L 23/14; C08L 23/16

(52) U.S. Cl. CPC C08J 3/226; B29C 48/022; B29C 48/397; B29C 48/40; C08J 11/06; C08K 5/14; C08L 23/12; C08L 23/142; C08L 23/16; B29C 2948/92561; B29C 2948/92704; B29K 2023/12; B29K 2023/14; B29K 2023/16; C08J 2323/12; C08J 2323/14; C08J 2323/16; C08L 2203/30; C08L 2205/025; C08L 2205/03; C08L 2207/02; C08L 2207/20

(57) ABSTRACT

A method for mechanical recycling of a polypropylene post-consumer resin may include adding a polypropylene-based masterbatch to a polypropylene post-consumer resin in a single screw extruder, wherein the polypropylene-based masterbatch comprises a low-reactivity free-radical generator compound having a half-life time greater than 20 h at 120° C.

### BACKGROUND

Some organic compounds, like peroxides and azo compounds, are commonly known as free-radical generators and initiators. In a process known as reactive extrusion of propylene polymers free-radical generators and initiators “crack” polymer molecules by decreasing viscosity of the polypropylene (PP) resin. Free radical generators and initiators with high surface area of the powders or spheres, as well as a process with high mixing capacity of the twin screw extruder, and a fast melting process, leads to a controlled and well understood reactive extrusion process.

In a plastics circular economy, the most effective process to reach a real circularity is mechanical recycling. Typical mechanical recycling uses single screw extruders due to the robustness and simplicity of the equipment. However, the melting and mixing process in single screw extruders is not as fast as in twin-screw extruders, thus resulting in some challenges to be overcome.

Conventional free-radical generator compounds are very reactive, and once added to an extruder, especially single screw extruders, it could lead to a premature reaction before a complete mixture is formed, thus generating problems of efficiency. The addition of typical free-radical generators to PP post-consumer resin (PCR) flakes is quite limited due to the competing processes of reactivity and dispersion, relatively low efficiency in melting the flakes, and low surface area of the PP-PCR flake geometry.

Hence, mixing typical free-radical generators with PP post-consumer resin (PCR) flakes is a difficult and unstable process with pressure oscillation. The usual tendency is to form a heterogeneous mixture with high concentration of peroxides ion flakes surface and not reacting inside all the polymer PCR mass.

Furthermore, handling liquid peroxides is dangerous due to their flammability, and recyclers do not typically have adequate storage facilities equipped to handle liquid peroxides. In addition to this storage issue, peroxide in liquid form is not the ideal form for feeding in the mechanical recycling process of PP-PCR, due to a smaller contact surface area of the PP-PCR flake to be recycled, when compared to powders or spheres. Therefore, this may cause problems in the humectation process and lead to instability in the final products.

Consequently, there is a need to achieve a safer and more efficient mechanical recycling process of PP-PCR flakes.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a polypropylene-based masterbatch containing a propylene polymer in an amount ranging from 50 to 97 wt. % and a low-reactivity free-radical generator compound having a half-life time greater than 20 h at 120° C. in an amount ranging from 3 to 50 wt. %, based on the total weight of the polypropylene-based masterbatch.

In another aspect, embodiments disclosed herein relate to a method for producing the polypropylene-based masterbatch that includes mixing a low-reactivity free-radical generator compound and a polypropylene resin in an extruder with a residence time less than 2 minutes and a temperature less than 200° C.

In a further aspect, embodiments disclosed herein relate to the use of a polypropylene-based masterbatch for visbreaking a polypropylene post-consumer resin in a reactive extrusion.

In a further aspect, embodiments disclosed herein relate to a method for mechanical recycling of a polypropylene post-consumer resin that includes adding a polypropylene-based masterbatch to a polypropylene post-consumer resin in an extruder, wherein the polypropylene-based masterbatch comprises a low-reactivity free-radical generator compound having a half-life time greater than 20 h at 120° C.

In another aspect, embodiments disclosed herein relate to a polymer composition, which includes a polypropylene post-consumer resin; and a polypropylene-based masterbatch, comprising: a propylene polymer, and a low-reactivity free-radical generator compound, wherein the low-reactivity free-radical generator compound has a half-life time of greater than 20 h at 120° C.

Other aspects and advantages of the claimed subject matter will be apparent from the following description and the appended claims.

### BRIEF DESCRIPTION OF DRAWINGS

FIG. 1 shows a reactivity comparison of a low-reactivity peroxide according to the present invention and conventional peroxides having higher reactivity measured in different media, according to data provided by the suppliers.

FIG. 2 shows the effect of single screw-extrusion versus twin screw extrusion on residence time.

FIG. 3 shows a correlation between half-life time and temperature for commercially available low-reactivity organic peroxide compounds.

FIG. 4 shows the effect of the relative length (L) for different single screw-extruder screw configurations on the amount of active peroxide.

FIG. 5 shows a plot of normalized intensity versus time of a masterbatch preparation according to the present invention.

FIG. 6 shows the estimated consumption of the peroxide compounds considering the relative L/D profile of the extruder in the masterbatch preparation.

FIG. 7 shows a plot of normalized intensity versus time of a method for mechanically recycling according to the present invention in a small extruder.

FIG. 8 shows the estimated consumption of the peroxide compounds considering the relative L/D profile of the extruder in a method for mechanically recycling according to the present invention in a small extruder.

FIG. 9 shows the plot of MFI versus the active oxygen (ppm) of LUPEROX 101 in liquid form in a method for mechanically recycling PP-PCR in a small extruder.

FIG. 10 shows the plot of complex viscosity versus angular frequency of LUPEROX 101 in liquid form in a method for mechanically recycling PP-PCR in a small extruder.

FIG. 11 shows the plot of MFI versus the active oxygen (ppm) of low-reactivity peroxide compounds K90, TAHP and TRIGONOX 311 in liquid form in a method for mechanically recycling PP-PCR in a small extruder.

FIG. 12 shows the plots of complex viscosity versus angular frequency of K90 in liquid form in a method for mechanically recycling PP-PCR in a small extruder.

FIG. 13 shows the plots of complex viscosity versus angular frequency of TAHP in liquid form in a method for mechanically recycling PP-PCR in a small extruder.

FIG. 14 shows the plots of complex viscosity versus angular frequency of TRIGONOX 311 in liquid form in a method for mechanically recycling PP-PCR in a small extruder.

FIG. 15 shows the plots of complex viscosity versus angular frequency of a PP-based masterbatch comprising K90 in a method for mechanically recycling PP-PCR in a small extruder.

FIG. 16 shows a comparison of the MFI response between K90 in liquid and masterbatch forms in a method for mechanically recycling PP-PCR in a small extruder.

FIG. 17 shows a comparison of the rheological behavior (complex viscosity versus the active oxygen) between the K90 in liquid and masterbatch forms in a method for mechanically recycling PP-PCR in a small extruder.

FIG. 18 shows the plots of complex viscosity versus angular frequency of a PP-based masterbatch comprising TAHP in a method for mechanically recycling PP-PCR in a small extruder.

FIG. 19 shows a comparison of the MFI response between TAHP in liquid and masterbatch forms in a method for mechanically recycling PP-PCR in a small extruder.

FIG. 20 shows a comparison of the rheological behavior (complex viscosity versus the active oxygen) between the TAHP in liquid and masterbatch forms in a method for mechanically recycling PP-PCR in a small extruder.

FIG. 21 shows the plots of complex viscosity versus angular frequency of a PP-based masterbatch comprising TRIGONOX 311 in a method for mechanically recycling PP-PCR in a small extruder.

FIG. 22 shows a comparison of the MFI response between TRIGONOX 311 in liquid and masterbatch forms in a method for mechanically recycling PP-PCR in a small extruder.

FIG. 23 shows a comparison of the rheological behavior (complex viscosity versus the active oxygen) between the TRIGONOX 311 in liquid and masterbatch forms in a method for mechanically recycling PP-PCR in a small extruder.

FIG. 24 shows the MFI responses for the variation of screw diameter when using LUPEROX 101 in liquid form and when using a PP-masterbatch comprising TRIGONOX 311 in a method for mechanically recycling PP-PCR in larger extruders.

FIG. 25 shows the plot of complex viscosity versus angular frequency when using LUPEROX 101 in liquid form and when using a PP-masterbatch comprising TRIGONOX 311 in a method for mechanically recycling PP-PCR in larger extruders.

FIG. 26 shows the plot of MFI versus the dosed content (%) of the peroxides (liquid LUPEROX 101 and masterbatch comprising TRIGONOX 311) in a method for mechanically recycling PP-PCR in an industrial extruder having 160 mm diameter.

FIG. 27 shows the plot of MFI versus the active oxygen (ppm) of the peroxides (liquid LUPEROX 101 and masterbatch comprising TRIGONOX 311) in a method for mechanically recycling PP-PCR in an industrial extruder having 160 mm diameter.

FIG. 28 shows the plot of complex viscosity versus angular frequency when using LUPEROX 101 in liquid form in an industrial extruder having 160 mm diameter.

FIG. 29 shows the plot of complex viscosity versus angular frequency when using a PP-masterbatch comprising TRIGONOX 311 in a method for mechanically recycling PP-PCR in an industrial extruder having 160 mm diameter.

### DETAILED DESCRIPTION

Embodiments disclosed herein relate to a polypropylene-based masterbatch containing a propylene polymer and a low-reactivity free-radical generator compound having a half-life time greater than 20 h at 120° C., based on the total weight of the polypropylene-based masterbatch. The propylene polymer is present in an amount ranging from 50 to 97 wt. %, based on the total weight of the polypropylene-based masterbatch.

Different from conventional virgin resins that are in powder or sphere form, having high superficial area and small particle size, post-consumer resins are usually in flake-form grinded to have an average size lower than 12 mm. Consequently, they have a small surface area available to be wetted with liquid peroxides. Hence, the polypropylene-based masterbatch containing the low-reactivity free-radical generator compound according to one or more embodiments disclosed herein avoids this surface area limitation of the PP-PCR flakes, delaying the extrusion reaction to ideal mixture conditions.

### Polypropylene-Based Masterbatch

In one aspect, embodiments disclosed herein relate to a polypropylene-based masterbatch composition containing a propylene polymer resin and a low-reactivity free-radical generator compound.

A “polypropylene-based masterbatch” is defined herein as a polymer mixture containing propylene polymer in an amount of from 50 wt. % to 97 wt. %, based on the total weight of the polypropylene-based masterbatch.

In one or more embodiments, the propylene polymer in the polypropylene-based masterbatch prepared by conventional extrusion has a melting point greater than or equal to 145° C. For example, the propylene polymer may have a melting point of at least 145° C. or 155° C., up to 175° C.

In one or more embodiments, the propylene polymer may be a propylene homopolymer.

In one or more embodiments, the propylene polymer may be a propylene copolymer with, such as a random propylene copolymer or a heterophasic propylene copolymer. In such embodiments, the propylene copolymer has less than or equal to 4 wt. % of a comonomer, such as ethylene or a C4-C8.

The polypropylene-based masterbatch of one or more embodiments includes a low-reactivity free-radical generator compound. In the context of the present invention, a low-reactivity free-radical generator compound is understood as a free-radical generator compound having a half-life time of greater than 20 h at 120° C. In one or more embodiments, the half-life time of the free-radical generator compound may be greater than 30 h, or greater than 50 h, or even greater than 100 h at 120° C.

The low-reactivity free-radical generator compound may include, but is not limited to, organic peroxide compounds, azo compounds and dicumene. For example, the low-reactivity free-radical generator compound may be selected from the group consisting of di(t-butyl) peroxide, 2,5-dimethyl-2,5-di(t-butylperoxy)-3-hexyne, 3,6,9-Triethyl-3,6,9-trimethyl-1,4,7-triperoxonane, 3,3,5,7,7-Pentamethyl-1,2,4-trioxepane, terc-butyl hydroperoxide, 1,2,4,5,7,8-Hexoxonane, 3,6,9-trimethyl-3,6,9-tris(Et and Pr), cumyl hydroperoxide, t-amyl hydroperoxide, 2,3-Dimethyl-2,3-diphenylbutane, and mixtures thereof.

The half-life time can be defined as the time required at a specific temperature, to affect a loss of one-half of the peroxide's active oxygen content. The half-life time according to embodiments disclosed herein is measured in a solvent, i.e., chlorobenzene or dodecane, at specific temperatures, and may be calculated according to the following equations and constants:

$${k}_{d} = A {e}^{- \frac{E a}{R T}} \qquad Equation 1$$

$${t}_{\frac{1}{2}} = ( \frac{ln ( 2 )}{{k}_{d}} ) \qquad Equation 2$$

where Eₐ=132.56 KJ/mole, A=1.15E¹² s⁻¹, R=8.3142 J/mole·K, T is temperature in K, k_{d} is the rate constant, and t_{1/2} is the half-life time.

Depending on the selection of the solvent used to characterizes the free-radical compound, there will be small changes in final constants, but not significantly different to impact the criteria of low reactivity peroxides according to the present invention. This can be seen in FIG. 1, which shows the comparison between a low-reactivity peroxide according to the present invention (TRIGONOX 311) and conventional peroxides having higher reactivity (LUPEROX 101 and TRIGONOX 101).

In one or more embodiments, the polypropylene-based masterbatch contains from about 3 wt. % to about 50 wt. % of the low-reactivity free-radical generator compound. The polypropylene-based masterbatch may contain the low-reactivity free-radical generator compound in a range having a lower limit of any one of 3, 5, 10 and 15 wt. % and an upper limit of any one of 20, 25, 30, 40, and 50 wt. % based on the total weight of the masterbatch, where any lower limit may be paired with any upper limit. In one or more embodiments, the polypropylene-based masterbatch contains from about 3 wt. % to about 40 wt. % of the low-reactivity free-radical generator compound. In one or more embodiments, the polypropylene-based masterbatch contains from about 5 wt. % to about 30 wt. % of the low-reactivity free-radical generator compound.

The polypropylene-based masterbatch may contain an additive. The polypropylene-based masterbatch may include any suitable additives, such as at least one inorganic filler, antioxidant, UV protectors, processing aids, friction controllers, slip agents, nucleating agents, coupling agents, grafting co-agents, anti-acid agents, and combinations thereof.

Examples of inorganic fillers may include, but are not limited to, silica, talc, alumina, TiO2, Calcium carbonate, silicates, glass fiber, natural fiber, synthetic fibers, and combinations thereof.

In one or more embodiments, the total amount of additives in the polypropylene-based masterbatch is in a range from about 0 wt. % to about 70 wt. %, such as a lower limit selected from any one of 0, 1, 3, 5, and 10 wt. % and an upper limit selected from any one of 30, 40, 50 and 70 wt. % based on the total weight of the masterbatch, where any lower limit may be paired with any upper limit.

In one or more embodiments, the amount of the at least one inorganic filler in the polypropylene-based masterbatch is in a range of from about 0 wt. % to about 15 wt. %, such as a lower limit selected from any one of 0, 0.01, 0.1, 0.5, 1, 3 and 5 wt. % to an upper limit selected from any one of 10, 12, and 15 wt. %, based on the total weight of the masterbatch, where any lower limit may be paired with any upper limit.

### Method to Prepare a Polypropylene-Based Masterbatch

In one aspect, embodiments disclosed herein relate to a method for preparing a polypropylene-based masterbatch.

In one or more embodiments, the polypropylene-based masterbatch may be prepared using a twin-screw extruder. Preparation of the polypropylene-based masterbatch may be accomplished in any suitable twin-screw extruder known in the art. In one alternative embodiment, the polypropylene-based masterbatch may be prepared using a single screw extruder.

In one or more embodiments, the method includes mixing a low-reactivity free-radical generator compound, a polypropylene resin, and, optionally, one or more additives in an extruder, preferably in a twin-screw extruder. The mixing in a twin-screw extruder has a more controlled residence time and extrusion temperature, thus avoiding the free-radical generator compound from reacting with the polypropylene resin.

In one or more embodiments, the residence time in the mixing step 2 minutes, such as less than about 90 seconds, such as less than 60 seconds, less than 40 seconds, and less than 25 seconds, and less than 15 seconds.

In one or more embodiments, the extrusion temperature in the mixing step is less than about 200° C., such as less than 180° C., less than 160° C., and less than 150° C.

### Use of a Polypropylene-Based Masterbatch

Embodiments disclosed herein relate to the use of a polypropylene-based masterbatch as previously described for visbreaking a polypropylene post-consumer resin in a reactive extrusion.

The polypropylene-based masterbatch provides a better dispersion and uniformity of reaction with a PP-PCR in the reactive extrusion, since it has a higher surface area than PP-PCR flakes, thus delaying the extrusion reaction to ideal mixture conditions.

### Mechanical Recycling of a Pp-PCR Using a Polypropylene-Based Masterbatch

Further embodiments disclosed herein relate to a method for improving the reactive extrusion for mechanical recycling of a polypropylene post-consumer resin (PP-PCR), which results in a better dispersion and uniformity of reaction. The method includes producing a polypropylene-based masterbatch containing a low-reactivity free-radical generator compound and adding the polypropylene-based masterbatch to a PP-PCR in an extruder.

In one aspect, embodiments disclosed herein relate to a method for mechanical recycling of a polypropylene post-consumer resin (PP-PCR) using a polypropylene-based masterbatch.

In one or more embodiments, the method for mechanical recycling includes blending the PP-PCR with a virgin polymer resin and mixing a polypropylene-based masterbatch with the PP-PCR.

In one embodiment, the method for mechanical recycling of a polypropylene post-consumer resin comprises adding a polypropylene-based masterbatch to the polypropylene post-consumer resin in an extruder. In a preferable embodiment, the method is carried out in a single-screw extruder but, alternatively, it can be also carried out in a twin-screw extruder.

The polypropylene-based masterbatch is according previously described.

In one alternative embodiment, the method for mechanical recycling includes also blending the PP-PCR with a virgin polymer resin and mixing a polypropylene-based masterbatch with the PP-PCR. For example, the virgin polymer may include, but is not limited to, virgin polypropylene, virgin polyethylene, or any combination thereof. Examples of the virgin polypropylene may include, but are not limited to, homopolymer, random copolymer, heterophasic copolymer, polypropylene blends such as polypropylene blends with polyethylene and polypropylene blends with EPDM, polypropylenes with elastomers, and any combination thereof.

In one or more embodiments, the polypropylene-based masterbatch may be added to the PP-PCR in an amount of from about 0.1 wt. % to about 20 wt. %, based on the total weight of PP-PCR, such as a lower limit selected from any one of 0.1, 0.2, 0.5, 1, and 5 wt. %, to an upper limit selected from any one of 7, 10, 15, and 20 wt. %, where any lower limit may be paired with any upper limit. In one or more embodiments, the polypropylene-based masterbatch may be added to the PP-PCR in an amount of from about 0.5 wt. % to about 10 wt. %, based on the total weight of the PP-PCR. In one or more embodiments, the polypropylene-based masterbatch may be added to the PP-PCR in an amount of from about 1 wt. % to about 5 wt. %, based on total weight of the PP-PCR.

In one or more embodiments, the PP-PCR includes polypropylene in an amount of from about 10 wt. % to about 100 wt. %, such as a lower limit selected from any one of 10, 15, 25, and 50 wt. % to an upper limit selected from any one of 60, 75, 90, and 100 wt. % based on the total weight of the PP-PCR. In one or more embodiments, the PP-PCR contains polypropylene in an amount of at least 50 wt. %, based on the total weight of the PP-PCR.

The PP-PCR may be derived from any source or may be a mixture of different sources, such as landfill, raffia films, bottles, non-woven materials.

In one or more embodiments, the PP-PCR may contain at least one non-propylene polymer in addition to polypropylene. In one or more embodiments, the PP-PCR contains polypropylene in an amount of from about 60 wt. % to about 99 wt. %, such as a lower limit selected from any one of 60, 70, and 80 wt. % and an upper limit selected from any one of 85, 95, and 99 wt. % and at least one non-propylene polymer in a range of from about 1 wt. % to 40 wt. % such as a lower limit selected from any of 1, 3, 5, and 10 wt. % and an upper limit selected from any one of 15, 25, 35, and 40 wt. % based on the total weight of the PP-PCR.

In one or more embodiments, the at least one non-propylene polymer may be an ethylene-based polymer, such as linear low-density polyethylene, low-density polyethylene and high-density polyethylene. Examples of ethylene-based polymers include, but are not limited to, ethylene homopolymers, and copolymers of ethylene and one or more olefins selected from C3 to C10 olefins.

In one or more embodiments, the mixing step in the method for mechanical recycling may be accomplished using a single-screw extruder. Mechanical recycling of a PP-PCR using a polypropylene-based masterbatch may be accomplished in any suitable single-screw extruder known in the art. In one or more embodiments, the single-screw extruder configuration may be any suitable configuration known in the art, such as one single screw extruder, or at least two single screw extruders in cascade or in parallel. Alternatively, the method for mechanical recycling may be accomplished using a twin-screw extruder.

In one or more embodiments, the mixing step in the method for mechanical recycling occurs at a temperature of less than about 350° C., such as a temperature of less than 300° C., less than 250° C., and less than 220° C. In one or more embodiments, the mixing step in the method for mechanical recycling occurs at a temperature in a range of from about 180° C. to about 230° C., such as a lower limit selected from any one of 180, 190, 195, and 200° C. to an upper limit selected from any one of 210, 220, and 230° C., where any upper limit may be paired with any lower limit.

In one or more embodiments, the mixing step in the method for mechanical recycling occurs at a residence time of at least 50 seconds, such as a residence time of at least 60 seconds, at least 100 seconds, and at least 300 seconds. In one or more embodiments, the residence time is at least 100 seconds. In one alternative embodiment, the residence time is no higher than 500 seconds.

### EXAMPLES

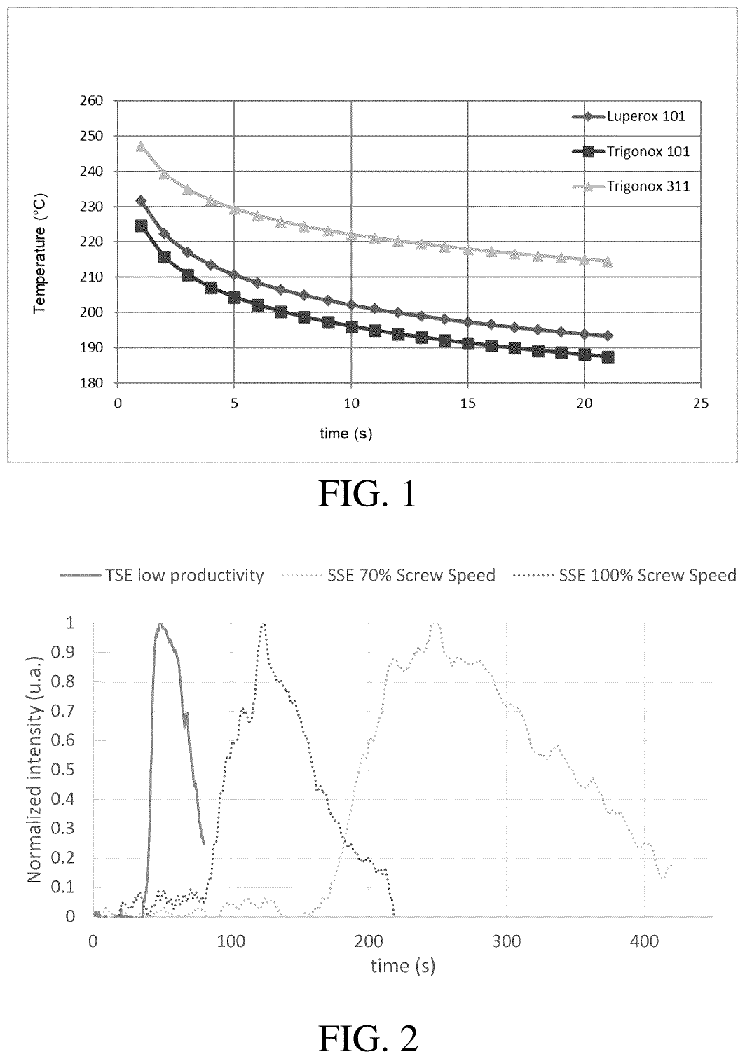

FIG. 2 is a plot of normalized intensity versus time in the extruder for a twin-screw extruder of low productivity compared to a single-screw extruder run at 70% screw speed and 100% screw speed. Residence time in the extruder was determined by adding a colored tracer to a polymer in the extruder feeder and recording intensity of the color which exited the extruder over time. Thus, the curves in FIG. 2 represent a residence time distribution, which indicates residence time of the polymer during extrusion. The twin-screw extruder has a residence time distribution which is short and narrow when compared to the single-screw extruder examples in FIG. 2. When the single-screw extruder is run at 70% screw speed, the residence time distribution is long and broad, whereas the residence time distribution becomes shorter and narrower when the single-screw extruder is run at 100% screw speed as shown in FIG. 2. The mechanism of melting polymer in a single screw extruder is much slower than a twin-screw extruder, and it is compensated by a much longer residence time.

Applying these findings in the context of embodiments disclosed herein, one can assume that a the free-radical initiator compound may react before the polymer is melted and reactive extrusion will not take place in a single-screw extruder running at 70% screw speed. Although reactive extrusion in a twin-screw extruder will have a shorter residence time as compared to when reactive extrusion takes place in a single-screw extruder, results in FIG. 2 show that a residence time of less than 150 seconds can be achieved when the single-screw extruder is run at 100% screw speed. The melting mechanism imposed to the polymer generates a capability to melt the polymer fast, in the early stages, due a specific screw profile, and generates an elevated degree of peroxide mixture, resulting in effective polymer reaction.

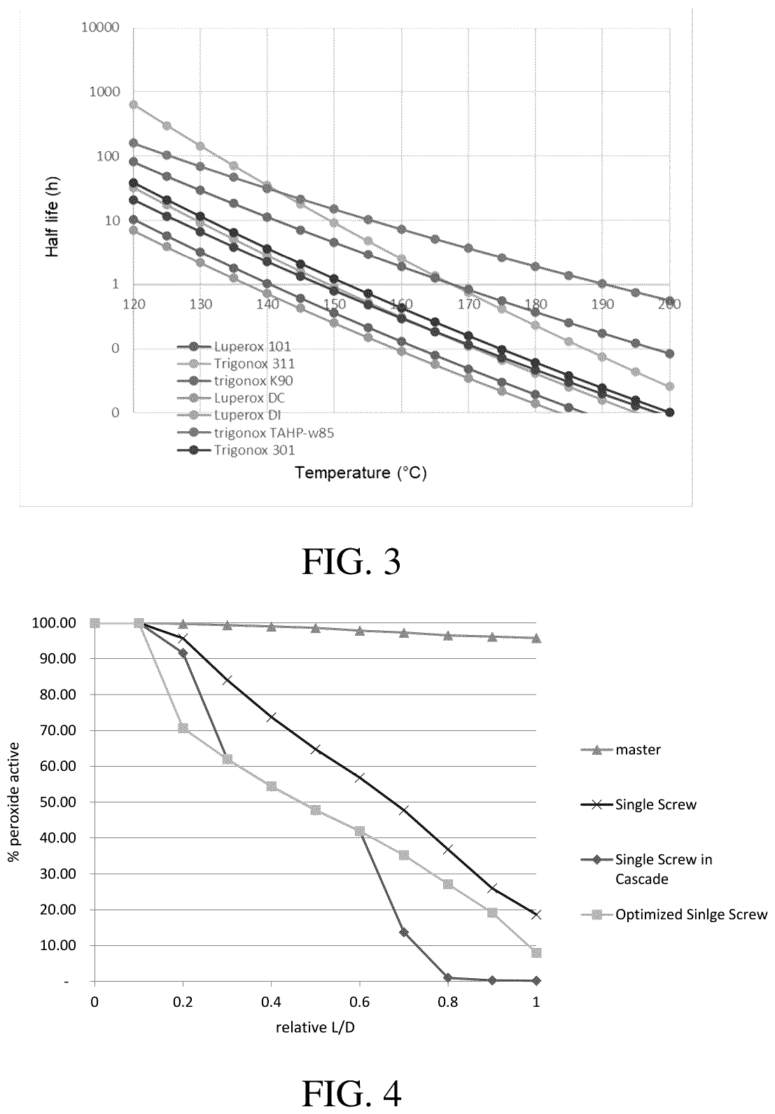

FIG. 3 shows a comparison of half-life time versus temperature for several different commercially available low-reactivity peroxide compounds. Comparative examples supplied by Arkema N. America (“Arkema”) include: LUPEROX 101 and LUPEROX DC, which have a half-life time of around 10 h at 120° C. On the other hand, Examples according to one or more embodiments disclosed herein include: Arkema's LUPEROX DI (di(t-butyl) peroxide), Nouryon Functional Chemicals B.V.'s (“Nouryon”) TRIGONOX 301 (1,2,4,5,7,8-Hexoxonane, 3,6,9-trimethyl-3,6,9-tris(Et and Pr)), and Arkema's LUPEROX 130 (2,5-dimethyl-2,5-di(t-butylperoxy)-3-hexyne), which have a half-life time of greater than 20 h at 120° C. Further examples according to one or more embodiments disclosed herein include: Nouryon's TRIGONOX k90, TRIGONOX 311 and TRIGONOX TAHP-w85, which have a half-life time greater than 50 h at 120° C.

The peroxides having half-life time of greater than 20 h at 120° C. demonstrated to have a much lower reactivity, being suitable to form the polypropylene-based masterbatch according to embodiments disclosed herein, without reacting with the polypropylene in the masterbatch preparation, and also to react adequately in extruders, especially single-screw extruders.

Considering the residence time depicted in FIG. 2, the operation temperature, and the reactivity coefficient of the peroxide compounds given in FIG. 3, it was possible to analyze the peroxide reaction behavior in masterbatch form for different types of screw configuration, as it can be seen in FIG. 4.

FIG. 4 shows the consumption of a peroxide compound in different screw configurations. FIG. 4 displays the active peroxide percentage versus relative screw length (L) for different screw configurations when a polypropylene-based masterbatch with peroxide is produced and used for degrading a PCR according to one or more embodiments.

According to FIG. 4, the master screw configuration represents the masterbatch preparation in a twin-screw extruder (TSE), showing that almost all the peroxide amount does not react with the polymer, since the temperature and residence time are low in the TSE. Therefore, after the masterbatch preparation, the peroxide is active and well mixed therein.

The prepared masterbatch was then applied in a typical single-screw, single-screw in cascade, or optimized single-screw configurations. It can be noted that such configurations are able to react nearly 100% of the peroxide. In other words, the screw configuration does not affect the mixing ability of a single-screw extruder to react/consume all of a low-reactive organic peroxide compound. Since the residence time is much higher in single-screw extruders (SSE), there is enough time for the low-reactivity organic peroxides to mix, react and incorporate into the PCR.

### Experimental Tests

Selection of the low-reactivity free-radical generator compound.

The low-reactivity free-radical generator compound was chosen by the criteria of reactivity and compared to conventional LUPEROX 101, provided by the peroxide suppliers:

TABLE 1

| | | | | | Half-life |
|---|---|---|---|---|---|
| | | | Ea | A | time at |
| Trade Name | Chemical Name | Solvent | (Kcal/mol) | (s⁻¹) | 120° C. |
| LUPEROX | 2,5-dimethyl-2,5-di(t- | dodecane | 37.182 | 8.7314E+15 | 10.3 h |
| 101 | butylperoxy)hexane | | | | |
| TRIGONOX | 2,5-Dimethyl-2,5-di(tert- | chlorobenzene | 37.318 | 1.680E+16 | 6.4 h |
| 101 | butylperoxy)hexane | | | | |
| TRIGONOX | tert-Butyl hydroperoxide | chlorobenzene | 44.642 | 3.18E+17 | 3984 h |
| A-w70 | | | | | |
| TRIGONOX | Cumyl hydroperoxide | chlorobenzene | 31.81437 | 1.15E+12 | 81 h |
| K90 | | | | | |
| TRIGONOX | 3,3,5,7,7-Pentamethyl- | chlorobenzene | 46.781 | 3.080E+19 | 635 h |
| 311 | 1,2,4-trioxepane | | | | |
| TRIGONOX | t-amyl hidroperoxide | chlorobenzene | 26.126 | 4.0484E+08 | 159 h |
| TAHP-w85 | | | | | |

Direct comparison of the peroxide compounds in same quantities is not accurate, since each peroxide compound may have a different content of active oxygen that will react and generate free radicals. To overcome this issue, peroxide quantity was normalized using the molecular weight and active oxygen criteria defined as the active oxygen available to react in the reactive extrusion, considering also the purity declared by the supplier. Thus, the equivalent amount of the peroxide compounds considering the active oxygen criteria is defined in Table 2, below in parts per million (ppm).

TABLE 2

| Active | | | | |
|---|---|---|---|---|
| O—O | 101 | TRIGONOX | TRIGONOX | TRIGONOX |
| (ppm) | (ppm) | K90 (ppm) | TAHP (ppm) | 311 (ppm) |
| 0 | — | — | — | — |
| 51 | 500 | 570 | 375 | 580 |
| 102 | 1000 | 1141 | 735 | 1167 |
| 203 | 2000 | 2217 | 1492 | 2323 |
| 305 | 3000 | 3413 | 2205 | 3491 |

### PP-Based Masterbatch Preparation

Considering the reactivity of the peroxide compounds described above, the PP-based masterbatches prepared in the inventive examples used TRIGONOX K90, TRIGONOX TAHP and TRIGONOX 311 as the low-reactivity free-radical generator compounds.

The masterbatches were prepared in a twin-screw extruder ZSK-26, diameter 25 mm and L/D 44, using the temperature profile: 120/175/185/185/185/180/180/180/175/175° C. The carrier resin used was a grinded PP having melt flow rate of 40 g/10 min, at temperatures lower than 180° C., as shown in the table below.

TABLE 3

| | | flow | | Screw | | Mass |
|---|---|---|---|---|---|---|
| Peroxide | Content | rate | SEI | Speed | Pressure | temperature |
| compound | (%) | (kg/h) | (Kwh/kg) | (rpm) | (bar) | (° C.) |
| TAHP | 10 | 20 | 0.108 | 200 | 3 | 176 |
| 311 | 10 | 20 | 0.103 | 200 | 3 | 179 |
| K90 | 10 | 20 | 0.104 | 200 | 4 | 179 |

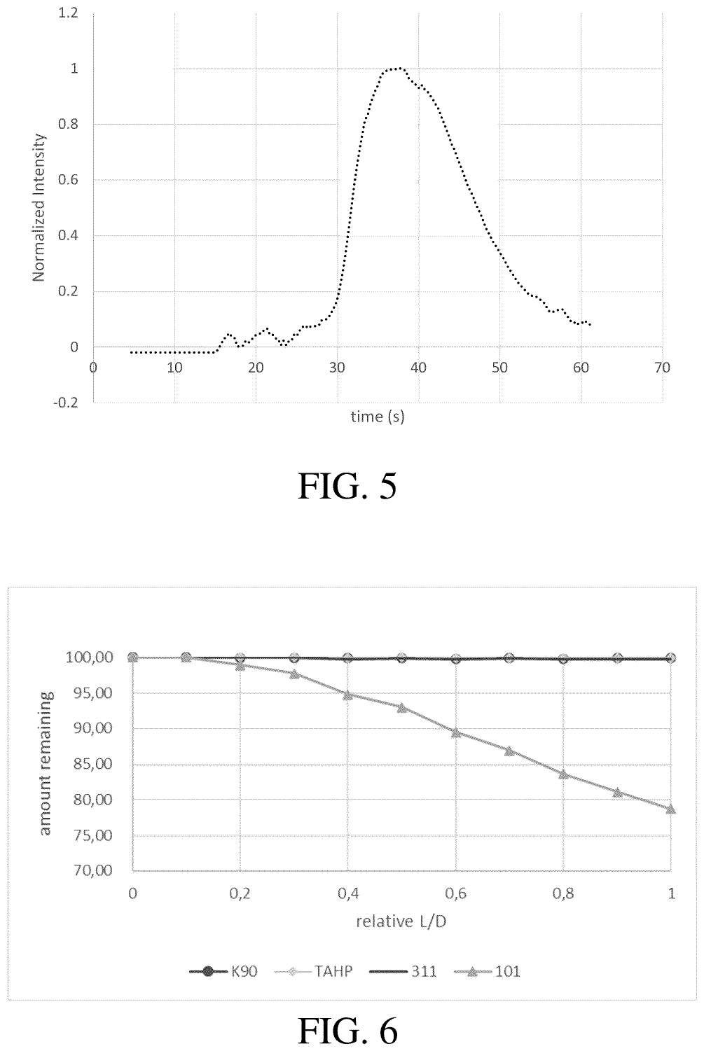

FIG. 5 shows the measured residence time for the prepared PP-based masterbatches as normalized intensity versus time. Assuming the median as the nominal residence time, it can be seen from FIG. 5 that the prepared PP-based masterbatches had an average residence time as around 39 s.

FIG. 6 shows an amount of remaining peroxide versus the relative extruder L/D for different peroxide types. Plotting the peroxides with those average time and temperature screw profile, it can be noted that less than 1% of peroxides according to the present invention have reached reactivity with the carrier resin, as shown in FIG. 6. On the other hand, a simulated comparative masterbatch comprising peroxide 101 would have consumed almost 20% of the peroxide, thus making the process unfeasible.

### Method for Mechanical Recycling of PP-PCR by Reactive Extrusion

Initially, trials were performed in a small single screw extruder, with diameter 30 mm, and L/D 32. The set temperature profile set was 160/170/180/190/200/210° C. The commercial flakes were initially ground to be possible to be feed in the small extruder followed by a manual mixture in a plastic bag of 3 kg of the grinded flakes and the desirable amount of the prepared masterbatch. The mixture was fed in the extruder hoper and the screw speed was 45 rpm. The screw set was 40/80/40 mesh.

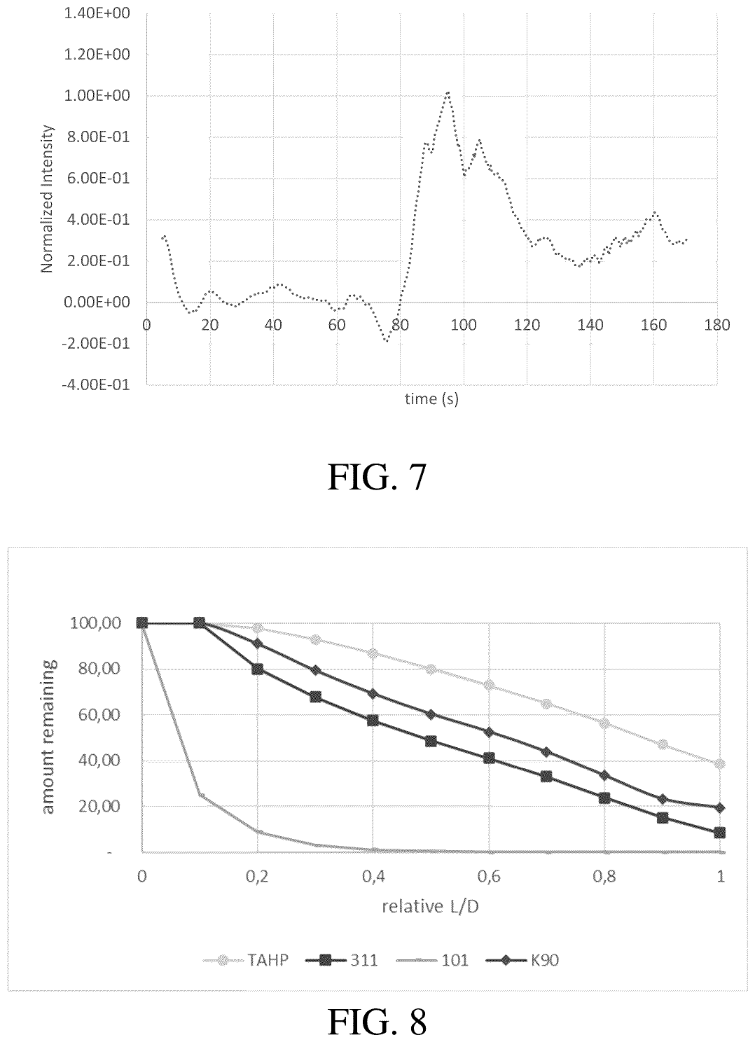

The residence time in the small extruder equipment can be seen below in FIG. 7. The PCR source has some internal pigments that increase the noise of the measurements. Since the amount of added peroxide, either in liquid or in masterbatch form, is low, the residence time in single-screw extrusion will not be affected. Hence, it could be estimated, using the same criteria described to the master, as a 110 s medium residence time (LUPEROX 101 as liquid).

FIG. 8 shows estimated peroxide consumption in the small extruder equipment. In FIG. 8, it can be seen that LUPEROX 101 in liquid form is consumed very fast due to its higher reactivity and its liquid form. However, the reaction primarily occurred on the surface of the PCR.

It can be noted that not all the peroxide amount was reacted in this small single extrusion process, so there are minor amounts of active peroxides after the extrusion. However, such active peroxide amount will react in the analysis of MFI (melt flow index) and/or rheology due to the increase of temperature, according to the parameters of ASTM. In MFI analysis, there is a soak time before measure, and in rheology a sample pressing step.

In the following examples, the melt flow index (MFI) was measured according to ASTM D 1238 (2.16 Kg/10 min at 230° C.), and rheological measurements were done at a TA DHR3, at 200° C., parallel disc of 25 mm, 1 mm gap, at a linear regime conditions of stress, from 0,0625 rad/s up to 625 rad/s (ASTM D4440).

### Comparative Example 1—Mechanical Recycling Method Using Liquid Reactive Peroxide, i.e., a Peroxide Compound Having a Half-Life Time Lower than 20 h at 120° C.

In this example, LUPEROX 101 peroxide in liquid form was used as the free-radical generator to modify the PCR-PP. LUPEROX 101 peroxide is a conventional compound used for visbreaking polypropylene resins and it has a half-life time of 10.3 h, i.e., lower than 20 h at 120° C.

The method for mechanically recycling the PP-PCR was carried out in the small single screw extruder as described above, at 45 rpm screw speed. From the table below, it is evident the issues for producing visbroken PP when using a single screw extruder using liquid peroxide LUPEROX 101. There is a decrease in the die pressure, as shown in Table 4, which is one of the main machine parameters, thus indicating a negative influence of this liquid peroxide.

TABLE 4

| Active | | | | |
|---|---|---|---|---|
| Oxygen | Amperage | Pressure | | Pressure |
| (ppm) | (A) | (bar) | Stable | range |
| 0 | 52 | 37 | yes | 36-38 |
| 51 | 47 | 13 | no | 9-19 |
| 102 | 47 | 12 | no | 8-16 |
| 203 | 47 | 11 | no | 7-17 |
| 305 | 47 | 9 | no | 6-17 |

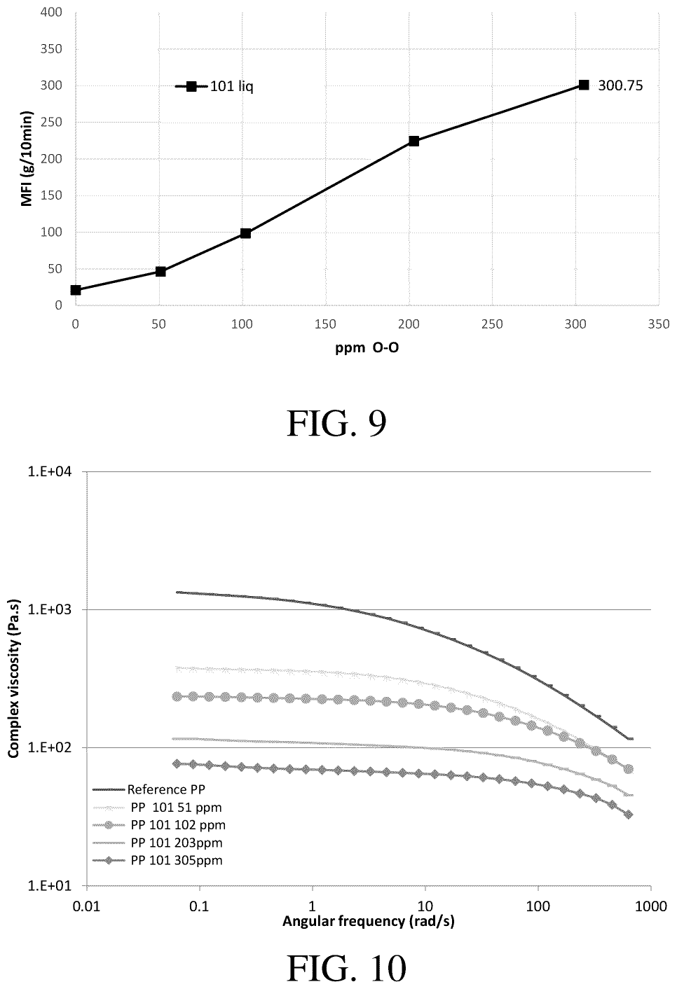

FIG. 9 shows the plot of MFI versus the active oxygen (ppm) of the LUPEROX 101 in liquid form, which can be correlated to the PP-PCR degradation. From FIG. 9, it can be noted an apparently significant increase in the melt flow index of the PP-PCR resin. However, to understand if a homogeneous reaction has occurred, a rheological analysis is needed, as shown in FIG. 10.

FIG. 10 is a plot of complex viscosity versus angular frequency. Up to 102 ppm of peroxide active oxygen, the degradation curve is quite similar to the historical virgin PP, with a constant viscosity at low angular frequencies, evidencing that a homogeneous reaction has occurred. The occurrence of a homogeneous reaction is explained due to the use of a small sized equipment. Increasing the amount of peroxide active oxygen to 203 ppm, the curve started showing a deviation/slope, indicating that a homogeneous reaction has not occurred. This can be explained as an effect of high concentration of the free radical generator in the flakes surface (not a homogenous mixture) before starting the reaction, leading to a high degradation of fractions mixture to few reaction molecules. Additionally, this negative effect could be even enhanced in larger equipment.

### Comparative Example 2

In this example, low-reactivity peroxides, i.e., having a half-life time greater than 20 h at 120° C., were applied to the PP-PCR source at the same conditions as those in the Examples, above. All of the peroxides were applied in liquid form.

TABLE 5

| Low- | Active | | | | |
|---|---|---|---|---|---|
| reactivity | Oxygen | Amperage | Pressure | | Pressure |
| peroxide | (ppm) | (A) | (bar) | Stable | range |
| K90 | 51 | 48 | 17 | no | 13-20 |
| | 102 | 48 | 12 | no | 10-15 |
| | 203 | 47 | 11 | no | 11-16 |
| | 305 | 47 | 11 | no | 10-16 |
| TAHP | 51 | 48 | 25 | no | 17-35 |
| | 102 | 48 | 23 | no | 15-30 |
| | 203 | 46 | 20 | no | 15-25 |
| | 305 | 46 | 18 | no | 13-24 |
| 311 | 51 | 46 | 22 | no | 15-32 |
| | 102 | 46 | 14 | no | 8-28 |
| | 203 | 46 | 12 | no | 6-18 |
| | 305 | 46 | 10 | no | 6-16 |

From Table 5, it can be observed that even using low-reactivity peroxide compounds with the aim to degrade the PP-PCR source, the reactive extrusion process is not stable due to the pressure oscillation.

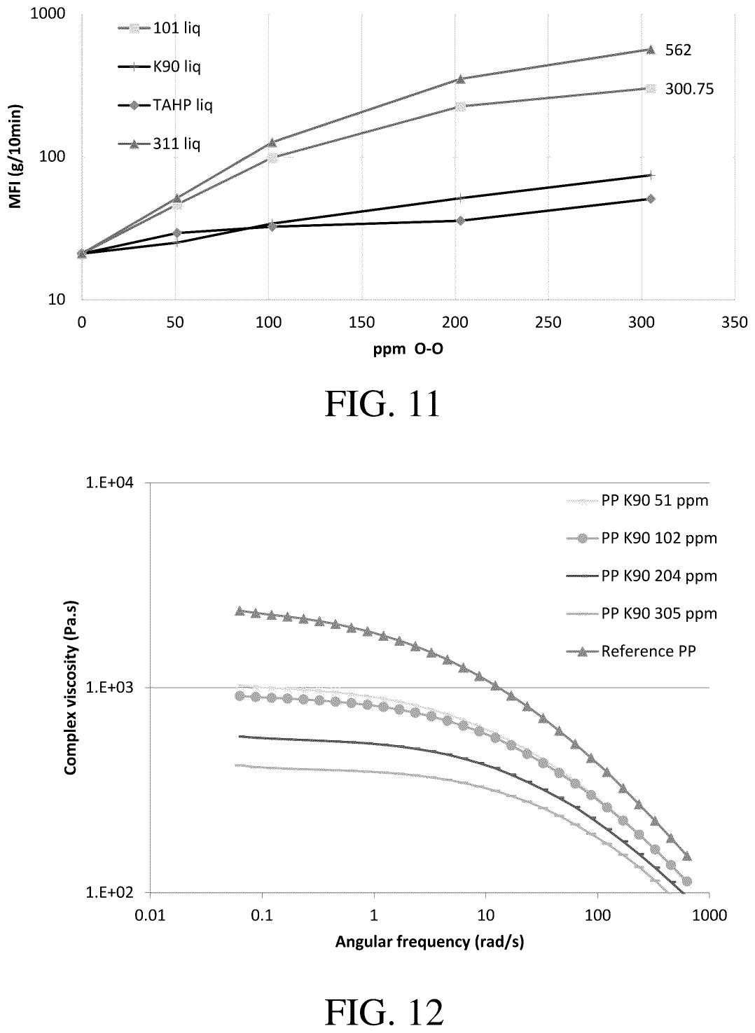

Using the low-reactivity peroxide compounds K90, TAHP and TRIGONOX 311, the following MFI responses to the peroxide active oxygen (ppm) can be observed in FIG. 11.

It can be seen that a pure peroxide, such as TRIGONOX 311, showed a very strong change in the MFI, which means a degradation similar to LUPEROX 101, while K90 and TAHP did not. This could be understood by the fact that they are diluted in water (K90 and TAHP), and water does not have affinity to PP liquid, being some barrier to dispersion. The water boiling during extrusion also could scavenger some peroxide amount that will not generate free radical to help in the degradation of PP mass.

However, the MFI responses are not reliable results for the PP-PCR degradation, since it could have poor mixture and the reaction occurring only at the flakes surface, as it was shown in comparative example 1.

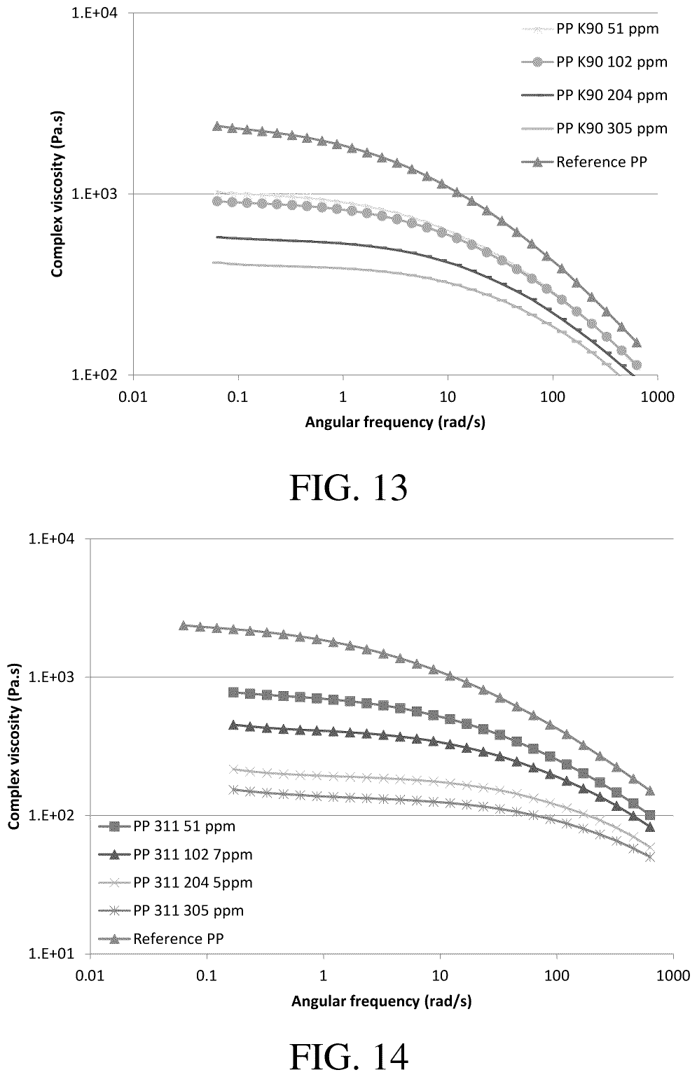

FIGS. 12, 13, and 14 show plots of complex viscosity versus angular frequency for each low-reactivity peroxide used.

From FIGS. 12, 13, and 14, it can be noted that low-reactivity peroxides bring the possibility to stabilize the degradation reaction, avoiding a premature reaction of the free radical generators and resulting in a more homogeneous reaction. Nevertheless, although these peroxide compounds result in a much more homogenous curve, they present low effectiveness in the reactive extrusion process.

### Inventive Example 1

The inventive example 1 uses the PP-based masterbatches comprising 10% (w/w) of TRIGONOX K90 produced as previously described to mechanical recycling the PP-PCR source.

TABLE 6

| | Active | | | | |
|---|---|---|---|---|---|
| | Oxygen | Amperage | pressure | | Pressure |
| | (ppm) | (A) | (bar) | Stable | range |
| Masterbatch | 51 | 48 | 16 | yes | 15-18 |
| (10% of K90) | 102 | 47 | 16 | yes | 15-18 |
| | 203 | 47 | 15 | yes | 14-17 |
| | 305 | 47 | 14 | yes | 13-15 |

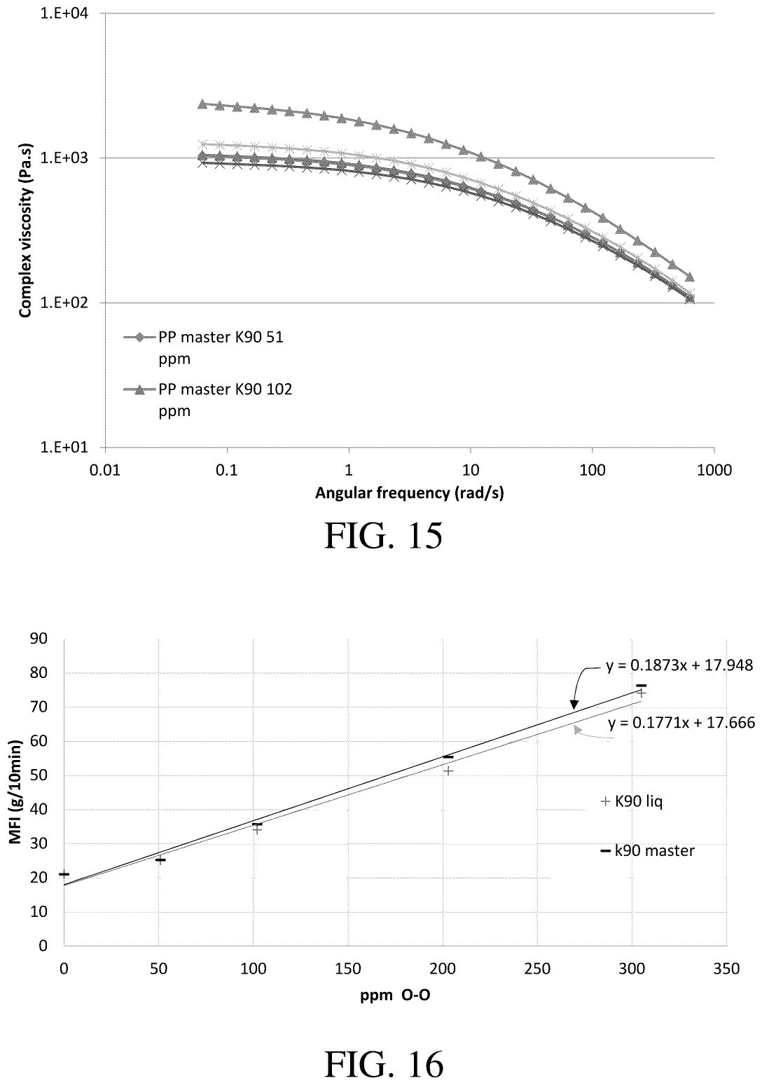

FIG. 15 shows a rheological analysis represented by the plot of complex viscosity versus angular frequency.

It can be seen from FIG. 15 that all modifications lead to a considered stable and homogeneous profile in rheological curve.

When comparing the use of K90 in liquid and masterbatch forms, it is possible to see a very similar MFI response, as it can be seen in FIG. 16.

However, as shown in FIG. 16, MFI responses are not reliable results for the PP-PCR degradation since it may lead to poor mixture and the reaction happening only at the flakes surface. Hence, the comparative response of rheological analysis is needed.

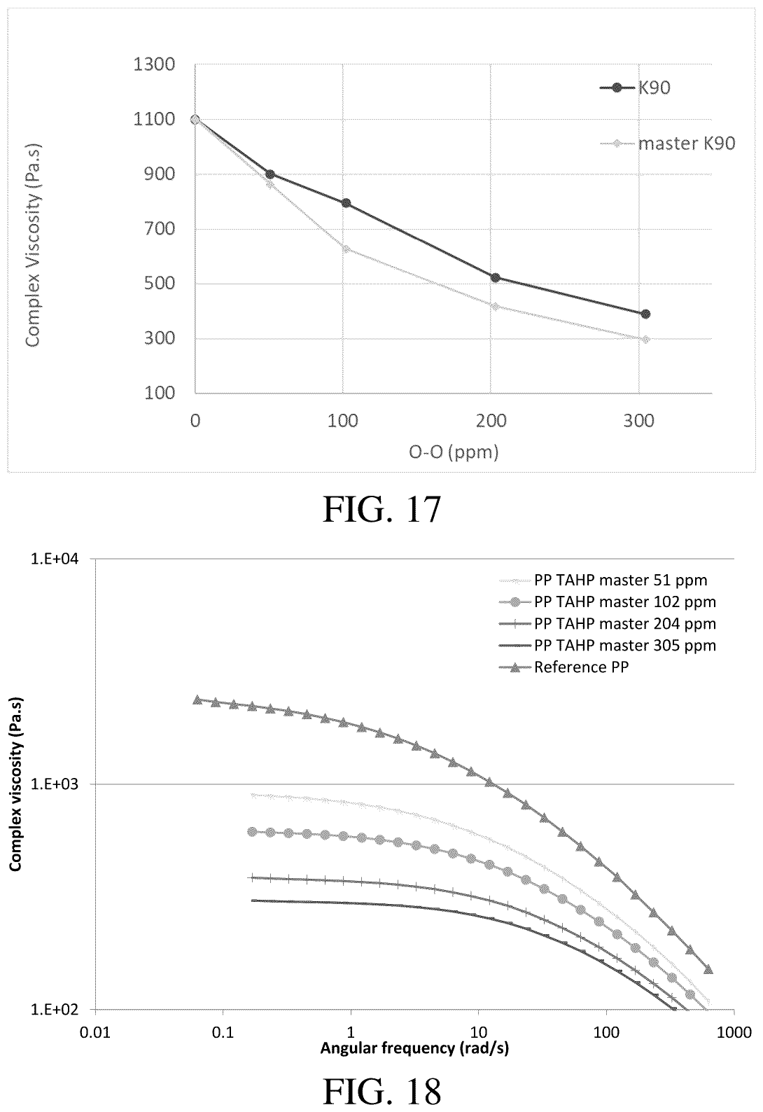

FIG. 17 shows the plot of complex viscosity versus the active oxygen, assuming the value at 1 rad/s as reference. From the plot in FIG. 17, the efficiency among the different forms of administering the peroxide compound, i.e., liquid or masterbatch form, to visbreak PP-PCR, may be compared. On this evaluation, it is possible to conclude that using TRIGONOX K90, the masterbatch route is slightly more efficient, attending the criteria of safety and homogeneity.

### Inventive Example 2

The inventive example 2 uses the PP-based masterbatches comprising 10% (w/w) of TRIGONOX TAHP produced as previously described to mechanical recycling the PP-PCR source.

TABLE 7

| | O—O | | | | |
|---|---|---|---|---|---|
| | content | Amperage | pressure | | |
| | ppm | (A) | (bar) | Stable | range |
| master | 51 | 46 | 16 | yes | 14-17 |
| TAHP | 102 | 46 | 16 | yes | 14-17 |
| | 203 | 45 | 14 | yes | 12-16 |
| | 305 | 45 | 12 | yes | 10-14 |

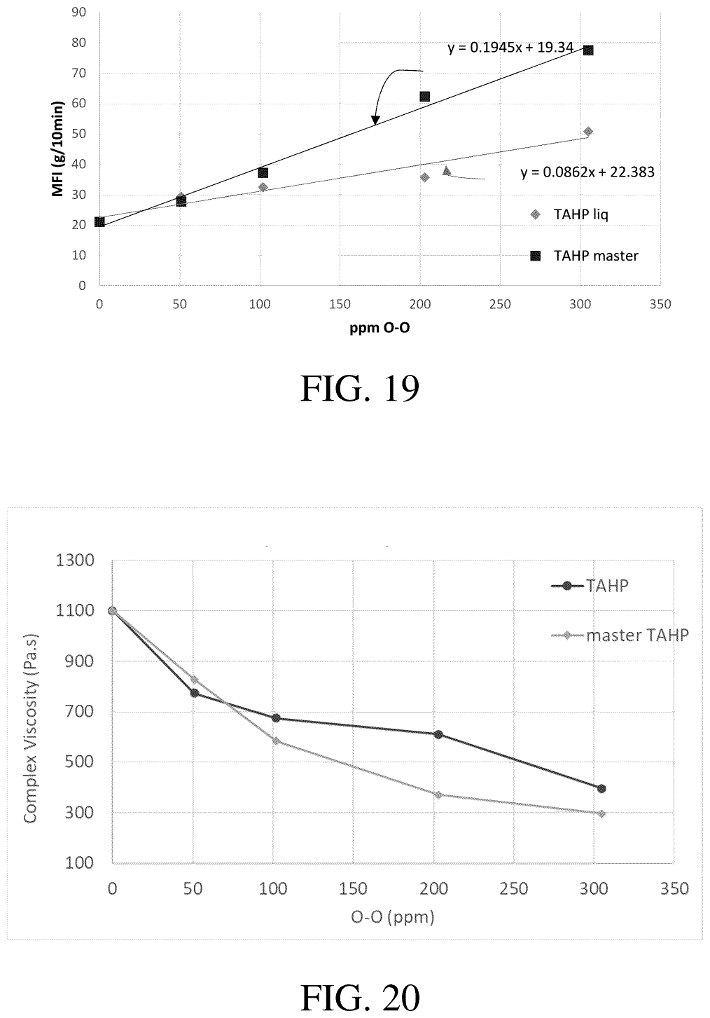

FIG. 18 shows a rheological analysis represented by the plot of complex viscosity versus angular frequency. Again, all the modifications lead to apparently homogeneous reaction in the small single screw extruder. When comparing the use of TAHP in liquid and masterbatch forms, it is possible to see TAHP in masterbatch form was much more effective, as it can be seen in FIG. 19 in the MFI response. This is also in line with the rheological analysis (complex viscosity versus active oxygen at 1 rad/s) as described in FIG. 20 below.

### Inventive Example 3

The inventive example 3 uses the PP-based masterbatches comprising 10% (w/w) of TRIGONOX 311 produced as previously described to mechanical recycling the PP-PCR source.

TABLE 8

| | O—O | | | | |
|---|---|---|---|---|---|
| | content | Amperage | pressure | | |
| | ppm | (A) | (bar) | Stable | range |
| Master | 51 | 45 | 14 | yes | 12-16 |
| 311 | 102 | 45 | 13 | yes | 11-15 |
| | 203 | 45 | 11 | yes | 9-13 |
| | 305 | 45 | 10 | yes | 7-11 |

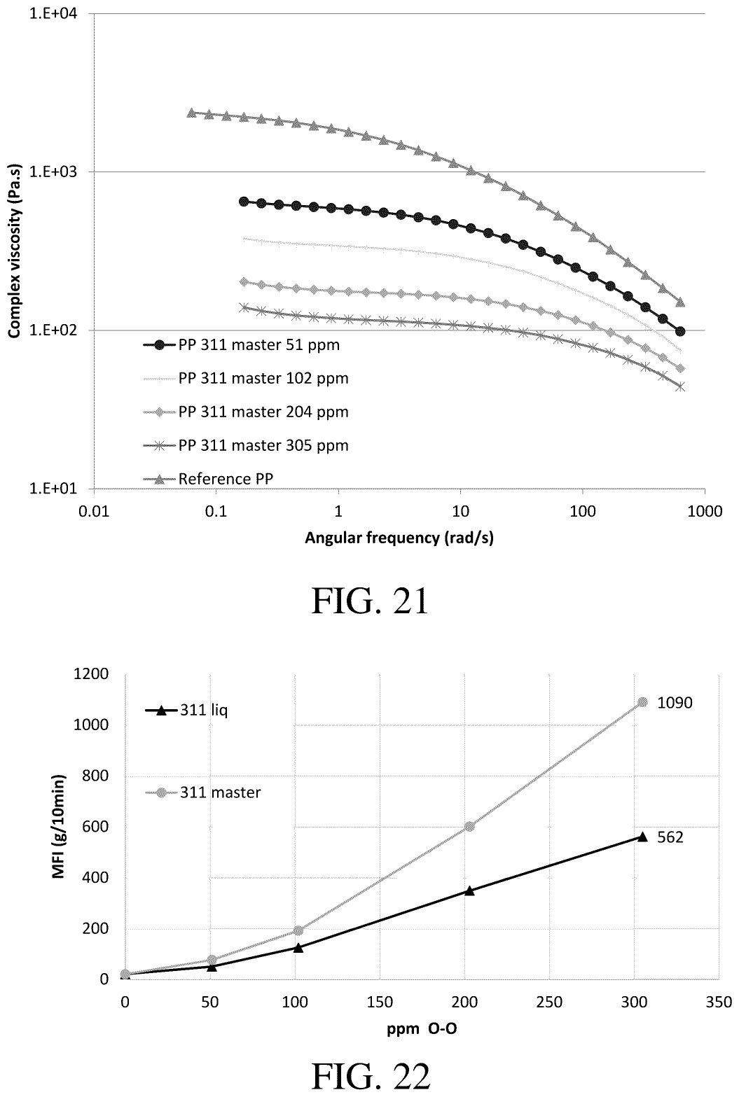

FIG. 21 shows a rheological analysis represented by the plot of complex viscosity versus angular frequency.

It can be seen from the plot above that curve' shapes demonstrate the characteristic of a more homogeneous reaction, when compared to the conventional peroxide compounds used for visbreaking polypropylenes, such as TRIGONOX 101 in liquid form (comparative example 1).

Comparing the use of TRIGONOX 311 in liquid and masterbatch form, the change in MFI became much higher than the accuracy of the measurement equipment, as can be expressed in FIG. 22.

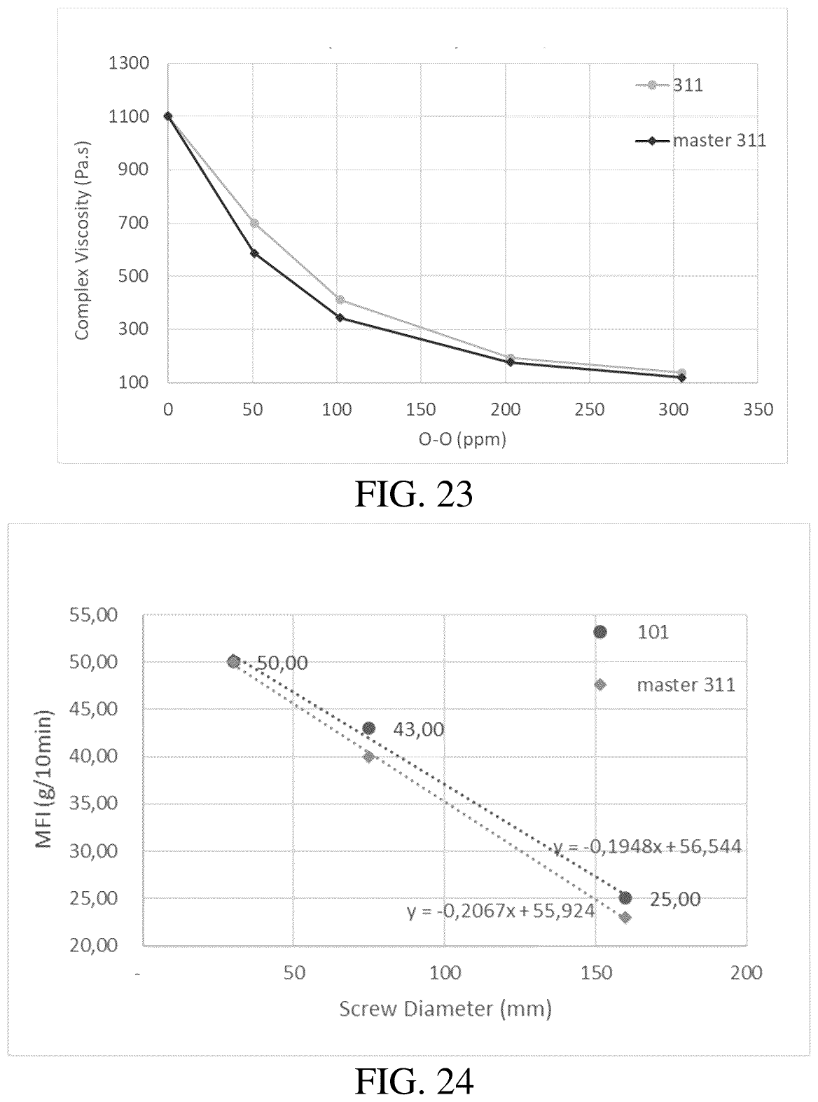

Rheological analysis, as already explained above, is much more trustable, and using the criteria of complex viscosity at 1 rad/s, it can be noted a slightly better response using TRIGONOX 311 in masterbatch form, also attending to the safety conditions of a masterbatch in a stable process as shown in FIG. 23.

### Inventive Example 4

In the previous inventive examples, the efficiency of the method for mechanical recycling PP-PCRs using masterbatches comprising low-reactivity free-radical generator compounds in small equipment was proven. The present example aims at proving the efficiency of the method in larger equipment.

The equipment used to perform the trials of inventive example 4 is listed in Table 9.

TABLE 9

| | Diameter | | | | Productivity |
|---|---|---|---|---|---|
| Equipment | (mm) | L/D | Mixing | Degassing | kg/h |
| 1 | 30 | 32 | Maddok | No | 6 |
| 2 | 75 | 32 | Pins | No | 100 |
| 3 | 160 | 41 | Pinaple | yes | 700 |

LUPEROX 101 and a polypropylene-based masterbatch comprising 10 wt. % of TRIGONOX 311 were tested in a method for mechanical recycling a PP-PCR and the results were compared. 0.45% (w/w) of the masterbatch comprising TRIGONOX 311 was added in the equipment 1, 2, and 3. A comparison was made adding 530 ppm of liquid LUPEROX 101 in the equipment 1, 2 and 3. Both quantities ordinarily have the same amount of final active oxygen.

The visbroken sample generated in these tests aimed the target of MFI 50 g/10 min, which is an interesting target for many applications, according to the results obtained in previous examples.

Looking at MFI results presented in FIG. 24, an efficiency reduction is observed when using larger single screw extruder diameter.

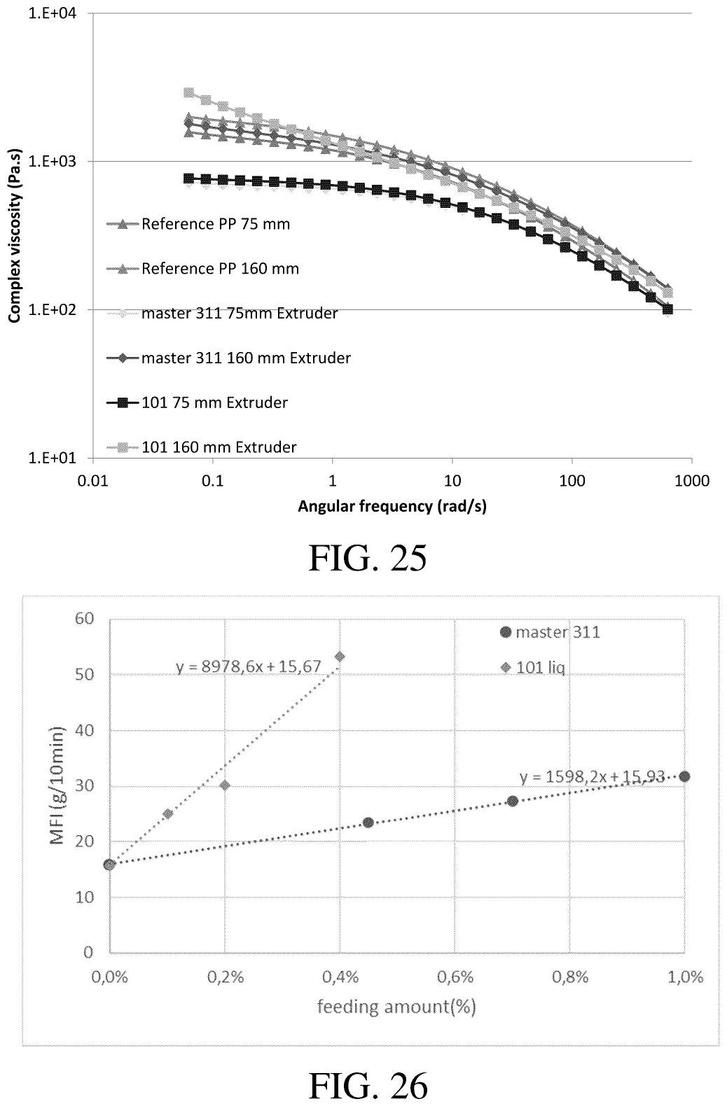

Although the peroxide efficiencies in liquid and masterbatch forms seem to be quite similar, the mechanism of dispersion of the PCR samples differs and thus they should be Theologically analyzed as shown in FIG. 25, as already explained.

Comparing the effects, it can be noted that when using equipment 2 (75 mm diameter) both liquid and masterbatch forms give an expected and historical curves profile and a lower efficiency compared to equipment 1 (30 mm diameter). The results in equipment 3 (160 mm diameter) presented an unexpected and strange profile when using LUPEROX 101 in liquid form. This indicates a huge heterogeneity in reaction, not only observed in the beginning of the curve, having higher viscosity than the original PP, but also observed in a significant drop in the viscosity at high angular frequencies. This heterogeneity can be correlated to the time to react the peroxide concentration in the surface of the flakes.

### Inventive Example 5

The present example aimed at comparing the amount of peroxides (in liquid and in masterbatch forms) fed in larger equipment. An industrial extruder having 160 mm diameter with gravimetric feeder was operated, so the amount of desired peroxide can be converted and expressed in %. Table 10 below shows the different amounts of the free radical generators (liquid LUPEROX 101 and masterbatch comprising TRIGONOX 311) added to the extruder.

TABLE 10

| | O—O | Master | O—O |
|---|---|---|---|
| 101 | ppm | 311 | ppm |
| 0.05% | 91 | 0.45% | 79 |
| 0.09% | 182 | 0.70% | 122 |
| 0.18% | 364 | 1% | 175 |

FIG. 26 is a plot of melt flow index versus the dosed peroxide content (%).

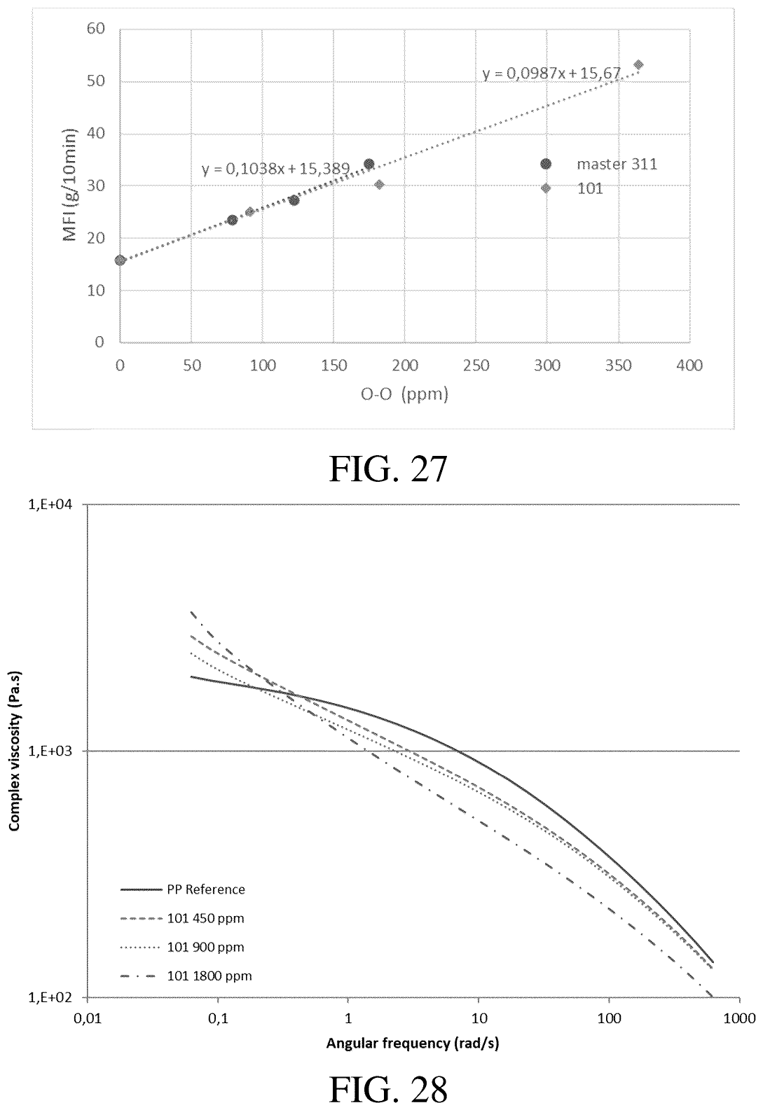

As already explained, the more reliable comparison is considering the active oxygen (ppm), which represents the real free radical content, instead of the dosed amount, as shown in FIG. 27.

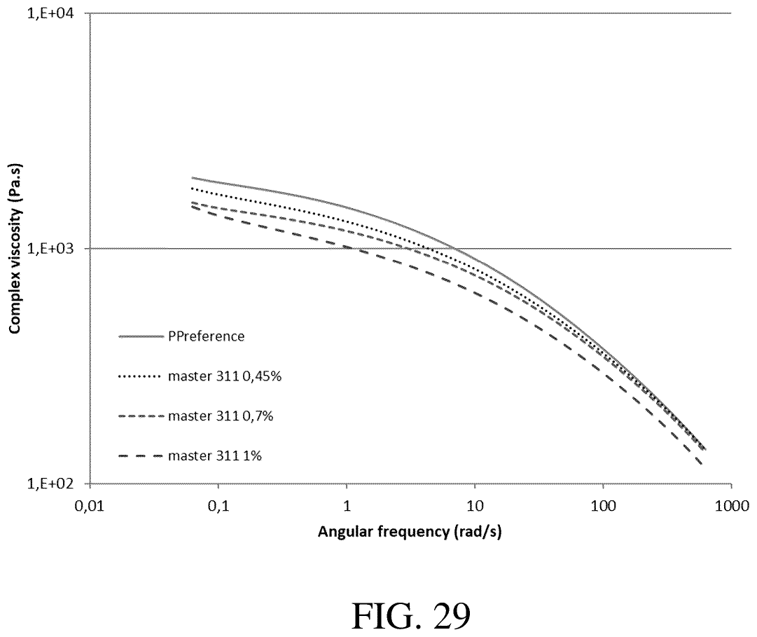

The final behavior was quite similar, presenting similar responses either using the liquid LUPEROX 101 or the masterbatch comprising TRIGONOX 311. On the other hand, the response at rheological curve brings another point of view about the routes, as can be seen in FIGS. 28 and 29.

From FIGS. 28 and 29, it is clear that the reactive extrusion using a low-reactivity free-radical generator compound masterbatch is much more homogeneous than the conventional liquid LUPEROX 101. Hence, the benefits to mechanical recycling are evident, mainly in applications that require processing stability with lower molecular weight distribution. Also, the process control becomes much more favorable and predictable using a common feeder/blender.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures.

What is claimed:

1. A polypropylene-based masterbatch comprising:
i) a propylene polymer in an amount ranging from 50 to 97 wt. %; and
ii) a low-reactivity free-radical generator compound having a half-life time greater than 20 h at 120° C. in an amount ranging from 3 to 50 wt. % based on a total weight of the polypropylene-based masterbatch.

2. The polypropylene-based masterbatch of claim 1, wherein the propylene polymer i) has a melting point of greater than or equal to 145° C. and/or the propylene polymer i) comprises a propylene homopolymer or a propylene copolymer comprising less than 4 wt. % of a comonomer, wherein the comonomer is ethylene or a C4-C8 α-olefin.

3. The polypropylene-based masterbatch of claim 1, wherein the low-reactivity free-radical generator compound is selected from the group consisting of organic peroxide compounds, azo compounds, dicumene, and mixtures thereof.

4. The polypropylene-based masterbatch of claim 3, wherein the low-reactivity free-radical generator compound is selected from the group consisting of di(t-butyl) peroxide, 2,5-dimethyl-2,5-di(t-butylperoxy)-3-hexyne, 3,6,9-Triethyl-3,6,9-trimethyl-1,4,7-triperoxonane, 3,3,5,7,7-Pentamethyl-1,2,4-trioxepane, terc-butyl hydroperoxide, 1,2,4,5,7,8-Hexoxonane, 3,6,9-trimethyl-3,6,9-tris(Et and Pr), cumyl hydroperoxide, t-amyl hydroperoxide, 2,3-Dimethyl-2,3-diphenylbutane, and mixtures thereof.

5. The polypropylene-based masterbatch of claim 1, wherein the low-reactivity free-radical generator compound has a half-life time of greater than 30 h at 120° C.

6. The polypropylene-based masterbatch of claim 1, wherein the low-reactivity free-radical generator compound has a half-life time of greater than 50 h at 120° C.

7. The polypropylene-based masterbatch of claim 1, wherein the polypropylene-based masterbatch comprises at least one inorganic filler in an amount less than 15 wt. %, based on the total weight of the polypropylene-based masterbatch.

8. A method for preparing the polypropylene-based masterbatch of claim 1, wherein the method comprises mixing the low-reactivity free-radical generator compound and the polypropylene resin in an extruder with a residence time less than 2 minutes and a temperature less than 200° C.

9. The method of claim 8, wherein the extruder is a single screw or a twin-screw extruder, and the mixing step is carried out with a residence time less than 40 seconds and with a temperature less than 180° C.

10. A method for mechanical recycling of a polypropylene post-consumer resin comprising: adding the polypropylene-based masterbatch of claim 1 to a polypropylene post-consumer resin in an extruder.

11. The method of claim 11, wherein the extruder is a single-screw or a twin-screw extruder and the method is carried out in a residence time of at least 50 seconds and at a temperature of less than 350° C.

12. The method of claim 11, wherein the extruder is a single-screw or a twin-screw extruder and the method is carried out in a residence time of at least 50 seconds at a temperature of from 180° C. to 230° C.

13. The method of claim 11, further comprising: blending the polypropylene post-consumer resin with a virgin polymer, wherein the virgin polymer is selected from the group consisting of polypropylene, polyethylene, and blends thereof.

14. The method of claim 11, wherein the polypropylene-based masterbatch is added to the polypropylene post-consumer resin in an amount of from about 0.1 wt. % to about 20 wt. %, based on the total weight of polypropylene post-consumer resin, and wherein the polypropylene post-consumer resin is derived from any source or a mixture of different sources selected from landfill, raffia films, bottles and non-woven materials.

15. The method of claim 11, wherein the polypropylene post-consumer resin comprises a propylene polymer, and optionally, at least one non-propylene polymer, wherein the propylene polymer is present in an amount of from 10 wt. % to 100 wt. % based on the total weight of the polypropylene post-consumer resin, and wherein the propylene polymer is selected from the group consisting of homopolymer, random copolymer, heterophasic copolymer, polypropylene blends, polypropylene blends with polyethylenes, polypropylene blends with EPDM, polypropylenes with elastomers, and mixtures thereof.

16. The method of claim 11, wherein the polymer composition comprises 60 wt. % to 99 wt. % of the propylene polymer and from 1 wt. % to 40 wt. % of the at least one non-propylene polymer, wherein the at least one non-propylene polymer is an ethylene-based polymer selected from the group consisting of ethylene homopolymers, ethylene copolymers, and one or more olefins selected from the group consisting of C3 to C10 olefins.

17. A polymer composition, comprising:
a polypropylene post-consumer resin; and
the polypropylene-based masterbatch of claim 1.

18. The polymer composition of claim 18, wherein the polypropylene post-consumer resin, comprises:
a propylene polymer; and
optionally, at least one non-propylene polymer,
wherein the propylene polymer is present in an amount of from 10 wt. % to 100 wt. % based on a total weight of the polypropylene post-consumer resin, wherein the propylene polymer is selected from the group consisting of homopolymer, random copolymer, heterophasic copolymer, polypropylene blends, polypropylene blends with polyethylenes, polypropylene blends with EPDM, polypropylenes with elastomers, and mixtures thereof.

19. The polymer composition of claim 18, wherein the polymer composition comprises 60 wt. % to 99 wt. % of the propylene polymer and from 1 wt. % to 40 wt. % of the at least one non-propylene polymer, wherein the at least one non-propylene polymer is an ethylene-based polymer selected from the group consisting of ethylene homopolymers, ethylene copolymers, and one or more olefins selected from the group consisting of C3 to C10 olefins.
